(19) United States
(12) Patent Application Publication
(10) Pub. No.: US 2019/0357105 A1
(43) Pub. Date: Nov. 21, 2019

(54) METHOD AND APPARATUS FOR REDUCING INTERRUPTION DELAY, AND USER DEVICE

(71) Applicant: CHINA ACADEMY OF TELECOMMUNICATIONS TECHNOLOGY, Beijing (CN)

(72) Inventors: Dajun ZHANG, Beijing (CN); Jiamin LIU, Beijing (CN)

(73) Assignee: China Academy of Telecommunications Technology, Beijing (CN)

(21) Appl. No.: 16/476,251

(22) PCT Filed: Feb. 5, 2018
(86) PCT No.: PCT/CN2018/075306

§ 371 Date: Jul. 5, 2019

(30) Foreign Application Priority Data
Jan. 6, 2017 (CN) 201710011298.X

(51) Int. Cl. H04W 36/18; H04W 36/38; H04W 36/00; H04W 36/14

(52) U.S. Cl. CPC H04W 36/18; H04W 36/38; H04W 88/06; H04W 36/14; H04W 36/0033

(57) ABSTRACT

A method and apparatus for reducing interruption delay, and a user device. The method is: in response to an anchor point change operation, a source main network entity of a source network side in a mobile communication network initiates an anchor point change request to a target main network entity of a target network side; on the basis of the received anchor point change request, the target main network entity configures and obtains target network side configuration parameters; on the basis of the received target network side configuration parameters, the source main network entity generates a radio resource control message for the target network side; the target main network entity obtains an anchor point reconstruction indication message generated and transmitted by a multi-connection user device on the basis of the radio resource control message, and enters a target network side configuration effective state for target network side reconstruction.

This application claims priority to Chinese Patent Application No. 201710011298.X, filed with the Chinese Patent Office on Jan. 6, 2017, and entitled “Method and apparatus for shortening an interruption delay, and User equipment”, which is hereby incorporated by reference in its entirety.

### FIELD

The present invention relates to the field of communications, and particularly to a method and apparatus for shortening an interruption delay, and a user equipment.

### BACKGROUND

A multi-connectivity user equipment refers to a user equipment which can be connected concurrently with more than two network entities. In a mobile communication network, e.g., a 2G, 2.5G, 3G, 4G, or 5G mobile communication network, or another higher-generation mobile communication network to be developed subsequently, a mobility access switching event is triggered when the multi-connectivity user equipment moves to a place where coverage areas of two network entities overlap with each other. In the existing methods for switching an access of a multi-connectivity user equipment, firstly transmission of user data at the source network side is interrupted, and after the access of the multi-connectivity user equipment is switched to a target network entity, user data are further transmitted, thus resulting in the technical problem that transmission of the user data may be interrupted for a long period of time.

In order to avoid transmission of the user data from being interrupted, there is also in the prior art a method for switching an access of a multi-connectivity user equipment, like the legacy DC operations, and specifically the target network entity is an SeNB, that is, an evolved Node B with a control-plane connection participates in communication at the network side during switching, so a data radio bearer mode between the user equipment and the network entities is a split Data Radio Bearer (DRB) mode. Since core-network signaling is not involved in this method, a signaling anchor is not changed, and there is a mobility access switching event at the RAN side, so the access can be switched without interrupting transmission of the user data.

There is also in the prior art a method for switching an access of a multi-connectivity user equipment based upon a specified anchor, and in this method, the multi-connectivity user equipment can access network entities including at least one separate Media Access Control (MAC) entity which is a physical network entity with an MAC address. In this method, one of more than two network entities which can be accessed by the multi-connectivity user equipment is configured as a primary network entity, and the other network entities are configured as secondary network entities, where the primary network entity is a network entity including a Packet Data Convergence Protocol (PDCP) function entity of signaling and/or data bearers, and also a termination point of core-network signaling connections and/or data connections, and the PDCP function entity of signaling and/or data bearers refers to a logic entity including security, compression, sorting, and other functions; and the secondary entities are network entities generally configured to transmit data, and including at least a radio link layer, a control protocol layer, an MAC layer, a physical layer, and other function entities for each data bearer, and the radio link layer, the control protocol layer, the MAC layer, the physical layer, and the other function entities include logic entities including segmentation, concatenation, multiplexing, scheduling, encoding, modulation, and other functions. In this method, the primary network entity is an anchor for the user data of the user equipment to move into and out of the mobile network, and a user address allocated by the primary network entity for the user equipment remains unchanged no matter whichever network entity to which the user equipment is switched, so the access can be switched without interrupting transmission of the user data as long as the anchor is not changed.

However the inventors of this application have identified during making of the technical solutions of the embodiments of the invention at least the following technical problem in the existing methods for switching an access of a multi-connectivity user equipment.

It is difficult for the network entity, with which the multi-connectivity user equipment is anchored, to remain unchanged all the time, and when the anchor is changed, the anchor may be migrated from the source primary network entity at the source network side to a secondary network entity at the source network side, so transmission of the user data still may be interrupted as the anchor is changed, and there may be a long interruption delay in transmission of the user data via an air interface of mobile communication. As the source network entity, with which the multi-connectivity user equipment is anchored, is changed, a processing load may be excessively localized, and there may be a long transmission path of the user data, thus inevitably degrading the operating performance of the mobile communication system as a whole.

### SUMMARY

The embodiments of the invention provide a method and apparatus for shortening an interruption delay, and a user equipment, so as to address the problem in the prior art that the operation performance of the mobile communication system may be degraded since the source network entity with which the multi-connectivity user equipment is anchored changes, to thereby enable user data to be transferred seamlessly.

Specific technical solutions according to the embodiments of the invention are as follows.

In a first aspect, an embodiment of the invention provides a method for shortening an interruption delay, applicable to a mobile communication network, the method including:

triggering, by a source primary network entity at a source network side in the mobile communication network, an anchor changing operation, wherein the anchor changing operation is an operation triggered by the source primary network entity selecting one of at least one source secondary network entity of the source network side as a target primary network entity based upon a radio resource management strategy of a multi-connectivity user equipment, and the source primary network entity is a source anchor of the multi-connectivity user equipment;

in response to the anchor changing operation, initiating, by the source primary network entity, an anchor changing request to the target primary network entity;

receiving, by the target primary network entity, the anchor changing request, and configuring and obtaining target network side configuration parameters of the target network side in the mobile communication network based upon the anchor changing request;

receiving, by the source primary network entity, the target network side configuration parameters, and generating a radio resource control message of the target network side based upon the target network side configuration parameters;

upon reception of an anchor reconstruction instructing message generated and transmitted by the multi-connectivity user equipment based upon the radio resource control message, entering, by the target primary network entity, a target network side configuration effective state; and

reconstructing, by the target primary network entity, the target network side based upon the anchor reconstruction instructing message and the target network side configuration parameters, so that the target primary network entity becomes a target anchor of the multi-connectivity user equipment, and the source primary network entity becomes one of target secondary network entities of the target network side.

In a possible implementation, receiving, by the target primary network entity, the anchor changing request, and configuring and obtaining the target network side configuration parameters of the target network side in the mobile communication network based upon the anchor changing request includes:

storing, by the target primary network entity, a position parameter of the target network side in the mobile communication network, and configuring and obtaining radio configuration parameters related to a signaling bearer at the target network side, and/or PDCP configuration parameters related to a data bearer at the target network side, based upon the anchor changing request.

In a possible implementation, the anchor changing request further includes radio configuration parameters related to a signaling bearer at the source network side, and/or PDCP configuration parameters related to a data bearer at the source network side; and

receiving, by the target primary network entity, the anchor changing request, and configuring and obtaining the target network side configuration parameters of the target network side in the mobile communication network based upon the anchor changing request further includes:

configuring and obtaining, by the target primary network entity, the radio configuration parameters related to the signaling bearer at the target network side based upon the radio configuration parameters related to the signaling bearer of the source network side in the anchor changing request, so that during reconstructing of the target network side, the target primary network entity changes a signaling endpoint and/or a data path of the core network from the source primary network entity to the target primary network entity based upon the target network side configuration parameters of the target network side in the mobile communication network; and

configuring and obtaining, by the target primary network entity, the PDCP configuration parameters related to the data bearer of the target network side based upon the PDCP configuration parameters related to the data bearer at the source network side in the anchor changing request, so that during reconstructing of the target network side, the target primary network entity migrates a PDCP entity in the source primary network entity to the target primary network entity based upon the target network side configuration parameters of the target network side in the mobile communication network.

In a possible implementation, the anchor changing request further includes security context information of the target network side; and receiving, by the target primary network entity, the anchor changing request, and configuring and obtaining the target network side configuration parameters of the target network side in the mobile communication network based upon the anchor changing request further includes:

selecting, by the target primary network entity, an encryption algorithm of the target network side based upon the security context information of the target network side.

In a possible implementation, the security context information of the target network side includes: a Key eNodeB Star parameter and a Next Hop Chaining Count parameter of the target network side.

In a possible implementation, receiving, by the source primary network entity, the target network side configuration parameters, and generating the radio resource control message of the target network side based upon the target network side configuration parameters includes:

receiving, by the source primary network entity, the target network side configuration parameters, and generating the radio resource control message of the target network side including the security context information of the target network side based upon the target network side configuration parameters.

In a possible implementation, the multi-connectivity user equipment can be in a target network side configuration effective state of the multi-connectivity user equipment, and can be reconstructed based upon the radio resource control message, after transmitting the anchor reconstruction instructing message to the target primary network entity.

In a possible implementation, the multi-connectivity user equipment is reconstructed based upon the radio resource control message in the steps of:

performing reconstructing and resetting operations at a media access control layer and a physical layer of the multi-connectivity user equipment;

performing a reconstructing operation at a PDCP layer of the multi-connectivity user equipment to enable the security context information of the target network side to take effect while keeping PDCP sequence numbers consecutive; and

reconstructing a control protocol entity at a radio link layer of the multi-connectivity user equipment, and delivering service data units in a downlink radio link layer control protocol to a higher layer out of order to reconstruct the multi-connectivity user equipment.

In a possible implementation, the anchor changing request further includes a target network side configuration effective time point; and receiving, by the target primary network entity, the anchor changing request, and configuring and obtaining the target network side configuration parameters of the target network side in the mobile communication network based upon the anchor changing request further includes:

generating, by the target primary network entity, a target network side configuration effective time point parameter among the target network side configuration parameters of the target network side in the mobile communication network based upon the target network side configuration effective time point, so that the target primary network entity enters a target network side configuration effective state when the target network side configuration effective time point arrives, and/or the multi-connectivity user equipment transmits the anchor reconstruction instructing message to the target primary network entity at the target network side configuration effective time point, and/or the multi-connectivity user equipment is in a target network side configuration effective state of the multi-connectivity user equipment, and is reconstructed based upon the radio resource control message, at the target network side configuration effective time point.

In a possible implementation, the radio resource management strategy of the multi-connectivity user equipment includes:

a radio channel characteristic management strategy, an operating load management strategy, and/or a path delay management strategy of the multi-connectivity user equipment.

In a possible implementation, reconstructing, by the target primary network entity, the target network side based upon the anchor reconstruction instructing message and the target network side configuration parameters includes:

starting, by the target primary network entity, the target network side to be reconstructed, based upon the anchor reconstruction instructing message;

performing, by the target primary network entity, resetting and reconstructing operations on the target primary network entity and all the target primary network entities of the target network side at a media access control layer and a physical layer of the target primary network entity based upon the anchor reconstruction instructing message or the target network side configuration parameters;

reconstructing, by the target primary network entity, a radio link layer control protocol entity based upon the anchor reconstruction instructing message or the target network side configuration parameters, and delivering service data units in the uplink radio link layer control protocol to a higher layer out of order;

performing, by the target primary network entity, a reconstructing operation at the PDCP layer based upon the target network side configuration parameters to enable security context information of the target network side to take effect while keeping PDCP sequence numbers consecutive; and

controlling, by the target primary network entity, the target primary network entity based upon the target network side configuration parameters to discard protocol data units which are not acknowledged in the downlink, to reconstruct the target network side.

In a possible implementation, the anchor reconstruction instructing message includes:

a physical layer reconstruction instructing message, a media access control layer reconstruction instructing message, and a radio resource control layer reconstruction instructing message for the target primary network entity and the target primary network entity.

In a second aspect, an embodiment of the invention provides an apparatus for shortening an interruption delay, applicable to a mobile communication network, the apparatus including:

an anchor changing operation obtaining module configured to trigger an anchor changing operation at a source network side in the mobile communication network, wherein the anchor changing operation is an operation triggered by a source primary network entity selecting one of at least one source secondary network entity of the source network side as a target primary network entity based upon a radio resource management strategy of a multi-connectivity user equipment, and the source primary network entity is a source anchor of the multi-connectivity user equipment;

an anchor changing request initiating module configured, in response to the anchor changing operation, to initiate an anchor changing request to the target primary network entity;

a target network side configuration parameter obtaining module configured to receive the anchor changing request, and to configure and obtain target network side configuration parameters of the target network side in the mobile communication network based upon the anchor changing request;

a radio resource control message generating module configured to receive the target network side configuration parameters, and to generate a radio resource control message of the target network side based upon the target network side configuration parameters;

a target network side configuration effective state entering module configured to enter a target network side configuration effective state upon reception of an anchor reconstruction instructing message generated and transmitted by the multi-connectivity user equipment based upon the radio resource control message; and

a target network side reconstructing module configured to reconstruct the target network side based upon the anchor reconstruction instructing message and the target network side configuration parameters, so that the target primary network entity becomes a target anchor of the multi-connectivity user equipment, and the source primary network entity becomes one of target secondary network entities of the target network side.

In a possible implementation, the target network side configuration parameter obtaining module is configured:

to store a position parameter of the target network side in the mobile communication network, and to configure and obtain radio configuration parameters related to a signaling bearer at the target network side, and/or PDCP configuration parameters related to a data bearer at the target network side, based upon the anchor changing request.

In a possible implementation, when the anchor changing request further includes radio configuration parameters related to a signaling bearer at the source network side, and/or PDCP configuration parameters related to a data bearer at the source network side,

the target network side configuration parameter obtaining module is further configured to configure and obtain the radio configuration parameters related to the signaling bearer at the target network side based upon the radio configuration parameters related to the signaling bearer of the source network side in the anchor changing request, so that during reconstructing of the target network side, the target primary network entity changes a signaling endpoint and/or a data path of the core network from the source primary network entity to the target primary network entity based upon the target network side configuration parameters of the target network side in the mobile communication network; and

to configure and obtain the PDCP configuration parameters related to the data bearer of the target network side based upon the PDCP configuration parameters related to the data bearer at the source network side in the anchor changing request, so that during reconstructing of the target network side, the target primary network entity migrates a PDCP entity in the source primary network entity to the target primary network entity based upon the target network side configuration parameters of the target network side in the mobile communication network.

In a possible implementation, when the anchor changing request further includes security context information of the target network side,

the target network side configuration parameter obtaining module is further configured to select an encryption algorithm of the target network side based upon the security context information of the target network side.

In a possible implementation, the security context information of the target network side includes:

a Key eNodeB Star parameter and a Next Hop Chaining Count parameter of the target network side.

In a possible implementation, the radio resource control message generating module is configured:

to receive the target network side configuration parameters, and to generate the radio resource control message of the target network side including the security context information of the target network side based upon the target network side configuration parameters.

In a possible implementation, the apparatus further includes an anchor reconstruction instructing message transmitting module, wherein:

the anchor reconstruction instructing message transmitting module is configured to cause the multi-connectivity user equipment to be in a target network side configuration effective state of the multi-connectivity user equipment, and to be reconstructed based upon the radio resource control message, after the multi-connectivity user equipment transmits the anchor reconstruction instructing message to the target primary network entity.

In a possible implementation, the apparatus further includes a multi-connectivity user equipment reconstructing module, wherein:

the multi-connectivity user equipment reconstructing module is configured to perform reconstructing and resetting operations at a media access control layer and a physical layer of the multi-connectivity user equipment;

to perform a reconstructing operation at the PDCP layer of the multi-connectivity user equipment to enable the security context information of the target network side to take effect while keeping PDCP sequence numbers consecutive; and

to reconstruct a control protocol entity at a radio link layer of the multi-connectivity user equipment, and to deliver service data units in a downlink radio link layer control protocol to a higher layer out of order to reconstruct the multi-connectivity user equipment.

In a possible implementation, when the anchor changing request further includes a target network side configuration effective time point,

the target network side configuration parameter obtaining module is further configured to generate a target network side configuration effective time point parameter among the target network side configuration parameters of the target network side in the mobile communication network based upon the target network side configuration effective time point, so that the target primary network entity enters a target network side configuration effective state when the target network side configuration effective time point arrives, and/or the multi-connectivity user equipment transmits the anchor reconstruction instructing message to the target primary network entity at the target network side configuration effective time point, and/or the multi-connectivity user equipment is in a target network side configuration effective state of the multi-connectivity user equipment, and is reconstructed based upon the radio resource control message.

In a possible implementation, the radio resource management strategy of the multi-connectivity user equipment includes:

a radio channel characteristic management strategy, an operating load management strategy, and/or a path delay management strategy of the multi-connectivity user equipment.

In a possible implementation, the target network side reconstructing module is configured to start the target network side to be reconstructed, based upon the anchor reconstruction instructing message;

to perform resetting and reconstructing operations on the target primary network entity and all the target primary network entities of the target network side at the media access control layer and the physical layer of the target primary network entity based upon the anchor reconstruction instructing message or the target network side configuration parameters;

to reconstruct a radio link layer control protocol entity based upon the anchor reconstruction instructing message or the target network side configuration parameters, and to deliver service data units in the uplink radio link layer control protocol to a higher layer out of order;

to perform a reconstructing operation at the PDCP layer based upon the target network side configuration parameters to enable the security context information of the target network side to take effect while keeping PDCP sequence numbers consecutive; and

to control the target primary network entity based upon the target network side configuration parameters to discard protocol data units which are not acknowledged in the downlink, to reconstruct the target network side.

In a possible implementation, the anchor reconstruction instructing message includes:

a physical layer reconstruction instructing message, a media access control layer reconstruction instructing message, and a radio resource control layer reconstruction instructing message for the target primary network entity and the target primary network entity.

In a third aspect, an embodiment of the invention provides a user equipment applicable to a mobile communication network, wherein:

the user equipment is configured to receive a radio resource control message of the target network side transmitted by a source primary network entity of the source network side in the mobile communication network with which the user equipment remains connected, wherein the radio resource control message of the target network side is configured and obtained by a target primary network entity based upon an anchor changing request transmitted by the source primary network entity; and

to generate an anchor reconstruction instructing message based upon the radio resource control message, and to transmit the anchor reconstruction instructing message to the target primary network entity at the target network side in the mobile communication network, so that the target primary network entity enters a target network side configuration effective state, and reconstructs the target network side, upon reception of the anchor reconstruction instructing message;

wherein the user equipment is capable of being connected concurrently with more than two network entities in the mobile communication network, and the source primary network entity is a source anchor of the multi-connectivity user equipment, the target primary network entity is selected by the source primary network entity from at least one source secondary network entity at the source network side based upon a radio resource management strategy of the multi-connectivity user equipment, and the target primary network entity is a target anchor of the multi-connectivity user equipment when the target network side is in the target network side configuration effective state.

In a possible implementation, the user equipment enters a target network side configuration effective state of the user equipment after transmitting the anchor reconstruction instructing message to the target primary network entity, or when a target network side configuration effective time point arrives.

In a possible implementation, after the user equipment enters the target network side configuration effective state of the user equipment, the user equipment performs reconstructing and resetting operations at a media access control layer and a physical layer of the multi-connectivity user equipment;

the user equipment performs a reconstructing operation at a PDCP layer of the multi-connectivity user equipment to enable security context information of the target network side to take effect while keeping PDCP sequence numbers consecutive; and

the user equipment reconstructs a control protocol entity at the radio link layer of the multi-connectivity user equipment, and delivers service data units in the downlink radio link layer control protocol to a higher layer out of order to reconstruct the multi-connectivity user equipment;

wherein the security context information of the target network side is included in the radio resource control message.

In the technical solutions above according to the embodiments of the invention, when a source primary network entity at the source network side in a mobile communication network, which is a source anchor, selects one of at least source secondary network entity of the source network side as a target primary network entity based upon a radio resource management strategy of a multi-connectivity user equipment, the source primary network entity triggers an anchor changing operation, responds to the anchor changing operation, and transmits an anchor changing request to the target primary network entity of the target network side, the target primary network entity receives the anchor changing request, and configures and obtains target network side configuration parameters based upon the anchor changing request, and the source primary network entity receives the target network side configuration parameters, and generates a radio resource control message of the target network side based upon the target network side configuration parameters; and the target primary network entity enters a target network side configuration effective state upon reception of an anchor reconstruction instructing message generated and transmitted by the multi-connectivity user equipment based upon the radio resource control message, and the target primary network entity becomes a target anchor of the multi-connectivity user equipment after systematically reconstructing the target network side. Stated otherwise, in the method and apparatus for shortening an interruption delay, and the user equipment according to the embodiments of the invention, such one of the source secondary network entities at the source network side that can make the best use of network resources is selected as a standby target anchor of the target network side based upon a condition of network resources available to the multi-connectivity user equipment, and the target network side configuration parameters are configured and obtained, so that the target anchor and the target network side configuration parameters can be optimized; and the target network side configuration can take effect to systematically reconstruct the target network side to thereby optimize a communication link related to the multi-connectivity user equipment, so as to improve the utilization ratio of a radio spectrum in a limited bandwidth, to lower operating loads of the multi-connectivity user equipment and the mobile communication network, to keep a signaling load as low as possible, and to enable user data to be transferred seamlessly, thus addressing the technical problem in the prior art of degrading the operating performance of the mobile communication system as a whole due to a change in network entity with which the multi-connectivity user equipment is anchored.

### BRIEF DESCRIPTION OF THE DRAWINGS

FIG. 1 is a schematic flow chart of a method for shortening an interruption delay according to an embodiment of the invention;

FIG. 2 is a schematic diagram of enabling a target network side configuration to take effect based upon an anchor changing instruction according to an embodiment of the invention;

FIG. 3 is a schematic diagram of enabling a target network side configuration at a target network side configuration effective time point according to an embodiment of the invention;

FIG. 4 is a schematic structural diagram of an apparatus for shortening an interruption delay according to an embodiment of the invention;

FIG. 5 is a schematic structural diagram of a mobile communication network according to an embodiment of the invention;

FIG. 6 is a physical architectural diagram of an apparatus for shortening an interruption delay according to an embodiment of the invention; and

FIG. 7 is a physical architectural diagram of a user equipment for shortening an interruption delay according to an embodiment of the invention.

### DETAILED DESCRIPTION

In order to make the objects, technical solutions, and advantages of the embodiments of the invention more apparent, the technical solutions according to the embodiments of the invention will be described below clearly and fully with reference to the drawings in the embodiments of the invention, and apparently the embodiments to be described below are only a part but not all of the embodiments of the invention. Based upon the embodiments here of the invention, all the other embodiments which can occur to those ordinarily skilled in the art without any inventive effort shall fall into the scope of the invention.

It shall be appreciated that the technical solutions according to the embodiments of the invention can be applicable to various communication systems, e.g., a Global System of Mobile communication (GSM) system, a Code Division Multiple Access (CDMA) system, a Wideband Code Division Multiple Access (WCDMA) system, a General Packet Radio Service (GPRS) system, a Long Term Evolution (LTE) system, a Long Term Evolution-Advanced (LTE-A) system, a Universal Mobile Telecommunication System (UMTS), etc.

It shall be further appreciated that in the embodiments of the invention, a User Equipment (UE) includes but will not be limited to a Mobile Station (MS), a mobile terminal, a mobile telephone, a handset, a portable equipment, etc., and the user equipment can communicate with one or more core networks over a Radio Access Network (RAN). For example, the user equipment can be a mobile phone (referred to as a “cellular” phone), a computer with a function of radio communication, etc., and the user equipment can also be a portable, pocket, handheld, built-in-computer, or on-vehicle mobile device.

In the embodiments of the invention, a base station (e.g., an access point) can be such a device in an access network that communicates with a radio terminal over one or more sectors via an air interface. The base station can be configured to convert a received air frame into an IP packet, and a received IP packet into an air frame, and operate as a router between the radio terminal, and the remaining components of the access network, where the remaining components of the access network can include an Internet Protocol (IP) network. The base station can further coordinate attribute management on the air interface, and for example, the base station can be a Base Transceiver Station (BTS) in a GSM or CDMA system, or can be a base station (Node B) in a WCDMA system, or can be an evolved base station (Node B or eNB or e-Node B) in an LTE system, although the invention will not be limited thereto.

In order to understand the technical solutions according to the embodiments of the invention clearly and fully, terms as to be referred to in the embodiments of the invention will be described below.

The term “Packet Data Convergence Protocol (PDCP)” refers to a protocol stack responsible for compressing and decompressing an IP header, transmitting service data, and maintaining sequence numbers of radio bearers, where the protocol stack is such a radio transmission protocol stack in a Universal Mobile Telecommunication System (UMTS) that is configured to process control-plane Radio Resource Management (RRC) messages, and user-plane Internet Protocol (IP) packets. A PDCP sub-layer belongs to the second layer of a radio interface protocol stack, and after an IP data packet from a higher layer is received at the user plane, the IP data packet is header-compressed and encrypted, and then delivered to a Radio Link Layer (RLC) control protocol sub-layer, and also the higher layer is further provided with in-order delivering and duplicated packet detecting functions; and at the control plane, the PDCP sub-layer provides the higher RRC layer with a signaling transmitting service, encrypts RRC signaling and protects RRC signaling for consistency, and decrypts RRC signaling and checks RRC signaling for consistency.

The term “Radio Resource Control (RRC)” refers to the third layer information for the control plane between a user equipment and an evolved Node B, where the first layer is the physical layer, the second layer is the media access control layer, and the third layer is the radio source control layer. A radio resource control message or an RRC message carries all the parameters required for setting up, modifying, and releasing the media access control layer and physical layer protocol entities, and also some signaling of the Non-Access Stratum, e.g., MM, CM, SM, etc. The radio resource control layer allocates radio resources and transmits related signaling, and control signaling between the user equipment and a terrestrial radio access network generally includes radio resource control messages.

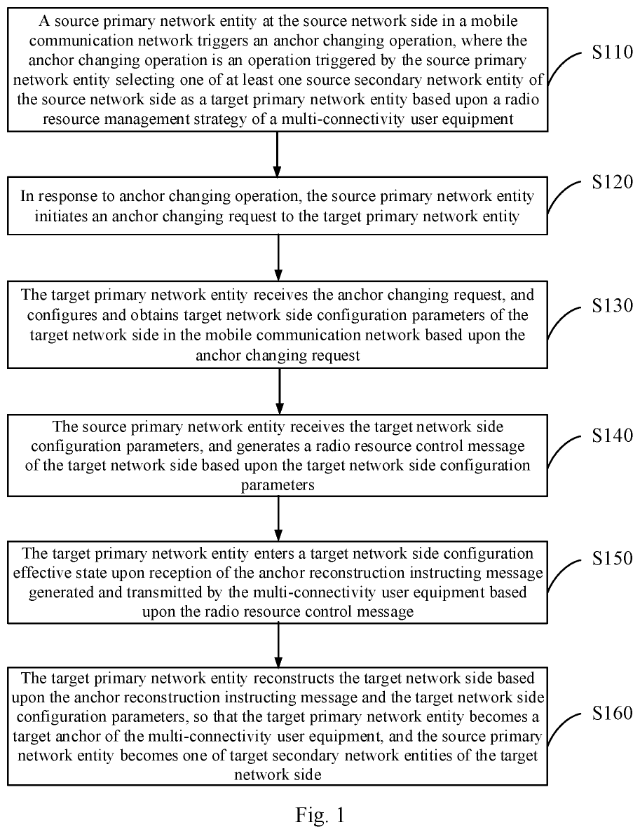

As illustrated in FIG. 1, a flow of a method for shortening an interruption delay according to an embodiment of the invention includes the following steps.

In the step S110, a source primary network entity at the source network side in a mobile communication network triggers an anchor changing operation, where the anchor changing operation is an operation triggered by the source primary network entity selecting one of at least one source secondary network entity of the source network side as a target primary network entity based upon a radio resource management strategy of a multi-connectivity user equipment, the source primary network entity is a source anchor of the multi-connectivity user equipment.

Specifically the multi-connectivity user equipment is a user equipment, with a wireless communication function, which can be connected concurrently with more than two network entities in the mobile communication network, and particularly can be a mobile phone, a smart mobile phone, a tablet computer, a notebook computer, or another wireless communication user equipment.

The mobile communication network is a 2G, 2.5G, 3G, 4G, or 5G mobile communication network, or another higher-generation mobile communication network to be developed subsequently.

The anchor is a network entity with which the user equipment is anchored in a core network, and an address allocated by the anchor for the user equipment can remain unchanged. While the user equipment is accessing the mobile network, user data of the user equipment move into and out of the core network through the anchor. Specifically the anchor can be but will not be limited to an evolved Node B, a mobility management entity, or a serving gateway.

In the embodiment of the invention, the radio resource management strategy of the multi-connectivity user equipment specifically can be but will not be limited to a radio channel characteristic management strategy, an operating load management strategy, and/or a path delay management strategy of the multi-connectivity user equipment.

In the step S120, in response to the anchor changing operation, the source primary network entity initiates an anchor changing request to the target primary network entity.

In the embodiment of the invention, the anchor changing request includes but will not be limited to:

Radio configuration parameters related to a signaling bearer at the source network side relates, and/or PDCP configuration parameters related to a data bearer at the source network side;

Security context information of the target network side, where the security context information of the target network side includes but will not be limited to a Key eNodeB Star parameter, a Next Hop Chaining Count parameter, and also possibly other parameters similar to these two parameters, of the target network side; and

A target network side configuration effective time point.

In the step S130, the target primary network entity receives the anchor changing request, and configures and obtains target network side configuration parameters of the target network side in the mobile communication network based upon the anchor changing request.

In the embodiment of the invention, the target primary network entity receives the anchor changing request, and configures and obtains the target network side configuration parameters of the target network side in the mobile communication network based upon the anchor changing request in the following four implementations without any limitation thereto.

In a first implementation, the target primary network entity stores a position parameter of the target network side in the mobile communication network, and configures and obtains radio configuration parameters related to a signaling bearer at the target network side, and/or PDCP configuration parameters related to a data bearer at the target network side, based upon the anchor changing request.

In a second implementation, further to the first implementation, the target primary network entity configures and obtains radio configuration parameters related to a signaling bearer at the target network side, based upon the radio configuration parameters related to the signaling bearer of the source network side in the anchor changing request, so that during reconstructing the target network side, the target primary network entity changes a signaling endpoint and/or a data path of the core network from the source primary network entity to the target primary network entity based upon the target network side configuration parameters of the target network side in the mobile communication network.

The target primary network entity configures and obtains PDCP configuration parameters related to a data bearer of the target network side based upon the PDCP configuration parameters related to the data bearer at the source network side in the anchor changing request, so that during reconstructing the target network side, the target primary network entity migrates a PDCP entity in the source primary network entity to the target primary network entity based upon the target network side configuration parameters of the target network side in the mobile communication network.

In a third implementation, further to the first implementation or the second implementation, the target primary network entity selects an encryption algorithm of the target network side based upon the security context information of the target network side.

In a fourth implementation, further to the first implementation, the second implementation, or the third implementation, the target primary network entity generates a target network side configuration effective time point parameter in the target network side configuration parameters of the target network side in the mobile communication network based upon the target network side configuration effective time point, so that the target network entity enters a target network side configuration effective state when the target network side configuration effective time arrives, and/or the multi-connectivity user equipment can transmits an anchor reconstruction instructing message to the target primary network entity, and/or the multi-connectivity user equipment can be in a multi-connectivity user equipment target network side configuration effective state, and can be reconstructed based upon a radio resource control message, at the target network side configuration effective time point.

In the step S140, the source primary network entity receives the target network side configuration parameters, and generates a radio resource control message of the target network side based upon the target network side configuration parameters.

In the embodiment of the invention, the source primary network entity receives the target network side configuration parameters, and generates a radio resource control message of the target network side based upon the target network side configuration parameters in the following implementation but without any limitation thereto.

The source primary network entity receives the target network side configuration parameters, and generates the radio resource control message of the target network side including the security context information of the target network side based upon the target network side configuration parameters.

In the step S150, the target primary network entity enters a target network side configuration effective state upon reception of the anchor reconstruction instructing message generated and transmitted by the multi-connectivity user equipment based upon the radio resource control message.

In the embodiment of the invention, the anchor reconstruction instructing message can include but will not be limited to:

An anchoring changing instruction; or

A physical layer reconstruction instructing message, a media access control layer reconstruction instructing message, and a radio resource control layer reconstruction instructing message for the target primary entity and the target primary entity.

In the step S160, the target primary network entity reconstructs the target network side based upon the anchor reconstruction instructing message and the target network side configuration parameters, so that the target primary network entity becomes a target anchor of the multi-connectivity user equipment, and the source primary network entity becomes one of target secondary network entities of the target network side.

In the embodiment of the invention, the target primary network entity reconstructs the target network side based upon the anchor reconstruction instructing message and the target network side configuration parameters in the following implementation without any limitation hereto.

The target primary network entity starts reconstructing of the target network side, based upon the anchor reconstruction instructing message.

The target primary network entity performs resetting and reconstructing operations on the target primary network entity and all the target primary network entities of the target network side at the media access control layer and the physical layer of the target primary network entity based upon the anchor reconstruction instructing message or the target network side configuration parameters.

The target primary network entity reconstructs a radio link layer control protocol entity based upon the anchor reconstruction instructing message or the target network side configuration parameters, and delivers service data units in the uplink radio link layer control protocol to a higher layer out of order.

The target primary network entity performs a reconstructing operation at the PDCP layer based upon the target network side configuration parameters to enable the security context information of the target network side to take effect while keeping PDCP sequence numbers consecutive.

The target primary network entity is controlled based upon the target network side configuration parameters to discard protocol data units which are not acknowledged in the downlink, to reconstruct the target network side.

In the embodiment of the invention, the multi-connectivity user equipment can be in a multi-connectivity user equipment target network side configuration effective state, and can be reconstructed based upon the radio resource control message, after transmitting the anchor reconstruction instructing message to the target primary network entity.

In the embodiment of the invention, the multi-connectivity user equipment performs reconstructing based upon the radio resource control message in the following steps.

The multi-connectivity user equipment performs reconstructing and resetting operations at the media access control layer and the physical layer of the multi-connectivity user equipment.

The multi-connectivity user equipment performs a reconstructing operation at the PDCP layer of the multi-connectivity user equipment to enable the security context information of the target network side to take effect while keeping PDCP sequence numbers consecutive.

The multi-connectivity user equipment reconstructs a control protocol entity at the radio link layer of the multi-connectivity user equipment, and delivers service data units in the downlink radio link layer control protocol to a higher layer out of order to reconstruct the multi-connectivity user equipment.

A process of shortening an interruption delay when the multi-connectivity user equipment triggers a mobility access switching event will be described below in details in connection with several particular embodiments thereof.

In a first specific embodiment, a target network side configuration can start to take effect based upon an anchor changing instruction, to reconstruct the target network side.

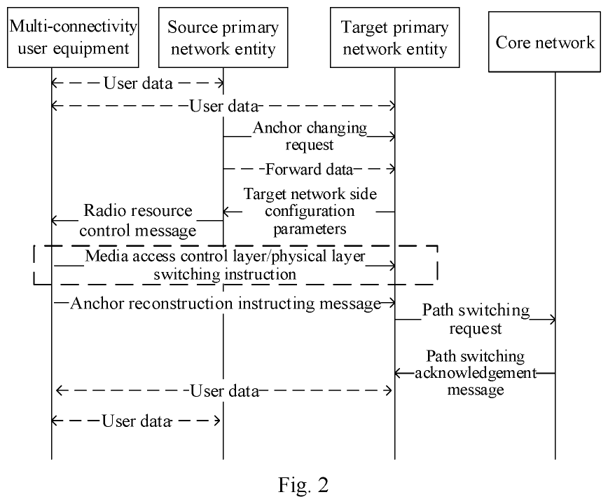

The multi-connectivity user equipment communicates data over the mobile communication network currently accessed by the multi-connectivity user equipment. The source network side of the mobile communication network includes a source primary network entity and at least one source secondary network entity, where the source primary network entity is a source anchor of the multi-connectivity user equipment, that is, while the multi-connectivity user equipment is communicating data through the source network side, user data of the multi-connectivity user equipment moves into and out of the core network through the source anchor. After the multi-connectivity user equipment moves to a place where coverage areas of two network entities overlap with each other, the mobile communication network triggers a mobility access switching event. In this first particular embodiment, the user data are transferred seamlessly by changing the anchor in the following specific process as illustrated in FIG. 2.

The source primary network entity selects one of the at least one source secondary network entity of the source network side as a target primary network entity based upon a radio channel characteristic management strategy, an operating load management strategy, a path delay management strategy, or another radio resource management strategy of the multi-connectivity user equipment, where the selecting triggers an anchor changing operation.

In response to the anchor changing operation, the source primary network entity initiates an anchor changing request to the target primary network entity, where the anchor changing request includes radio configuration parameters related to a signaling bearer at the source network side, and/or PDCP configuration parameters related to a data bearer at the source network side, security context information of the target network side including a Key eNodeB Star parameter, a Next Hop Chaining Count parameter, and other similar parameters, of the target network side, etc.

The target primary network entity receives the anchor changing request, configures and obtains target network side configuration parameters of the target network side in the mobile communication network based upon the anchor changing request, and transmits them to the source primary network entity. Specifically the target primary network entity stores a position parameter of the target network side in the mobile communication network; the target primary network entity configures and obtains radio configuration parameters related to a signaling bearer at the target network side based upon the radio configuration parameters related to the signaling bearer at the source network side in the anchor changing request; the target primary network entity configures and obtains PDCP configuration parameters related to a data bearer at the target network side relates based upon the PDCP configuration parameters related to the data bearer at the source network side in the anchor changing request; the target primary network entity selects an encryption algorithm of the target network side based upon the security context information of the target network side; and the target primary network entity updates radio parameters of the physical layer, the media access control layer, and the radio resource control layer of the target primary network entity.

The source primary network entity receives the target network side configuration parameters, generates a radio resource control message of the target network side including the security context information of the target network side based upon the target network side configuration parameters, and transmits it to the multi-connectivity user equipment.

Upon reception of the radio resource control message, the multi-connectivity user equipment generates an anchor reconstruction instructing message based upon the radio resource control message, transmits the anchor reconstruction instructing message and an anchor changing instruction to the target primary network entity, and then enters the target network side configuration effective state of the multi-connectivity user equipment. The anchor reconstruction instructing message includes a physical layer reconstruction instructing message, a media access control layer reconstruction instructing message, and a radio resource control layer reconstruction instructing message for the target primary network entity and the target primary network entity.

After the multi-connectivity user equipment enters the target network side configuration effective state of the multi-connectivity user equipment, it is reconstructed based upon the radio resource control message specifically by performing reconstructing and resetting operation at the media access control layer and the physical layer of the multi-connectivity user equipment, performing a reconstruction operation at the PDCP layer of the multi-connectivity user equipment to enable the security context information of the target network side take effect while keeping PDCP sequence numbers consecutive, reconstructing a control protocol entity at the radio link layer of the multi-connectivity user equipment, and delivering service data units in the downlink radio link layer control protocol to a higher layer out of order to reconstruct the multi-connectivity user equipment. While the multi-connectivity user equipment is being reconstructed, the multi-connectivity user equipment can create and transmit a PDCP state report to the target network side.

Upon reception of the anchor reconstruction instructing message generated and transmitted by the multi-connectivity user equipment based upon the radio resource control message, the target primary network entity enters the target network side configuration effective state based upon the anchor changing instruction; and after the target primary network entity enters the target network side configuration effective state, it changes a signaling endpoint and/or a data path of the core network from the source primary network entity to the target primary network entity based upon the target network side configuration parameters of the target network side in the mobile communication network, that is, a path switching operation on the core network is completed. The switching operation is similar to a path switching operation subsequent to legacy X2 switching.

The target primary network entity reconstructs the target network side based upon the anchor reconstruction instructing message and the target network side configuration parameters, so that the target primary network entity becomes the target anchor of the multi-connectivity user equipment, the source primary network entity becomes one of target secondary network entities of the target network side. The target network side is reconstructed as follows: the target primary network entity starts the target network side to be reconstructed, based upon the anchor reconstruction instructing message; the target primary network entity migrates a PDCP entity in the source primary network entity to the target primary network entity based upon the target network side configuration parameters of the target network side in the mobile communication network; the target primary network entity performs resetting and reconstructing operations on the target primary network entity and all the target primary network entities of the target network side at the media access control layer and the physical layer of the target primary network entity based upon the anchor reconstruction instructing message or the target network side configuration parameters; the target primary network entity reconstructs a radio link layer control protocol entity based upon the anchor reconstruction instructing message or the target network side configuration parameters, and delivers service data units in the uplink radio link layer control protocol to a higher layer out of order; the target primary network entity performs a reconstructing operation at the PDCP layer based upon the target network side configuration parameters to enable the security context information of the target network side to take effect while keeping PDCP sequence numbers consecutive; and the target primary network entity is controlled based upon the target network side configuration parameters to discard protocol data units which are not acknowledged in the downlink, to reconstruct the target network side. While the target network side is being reconstructed, the target primary network entity can create and transmit a PDCP state report to the multi-connectivity user equipment.

In a second specific embodiment, a target network side configuration start to take effect based upon a target network side configuration effective time point to reconstruct the target network side.

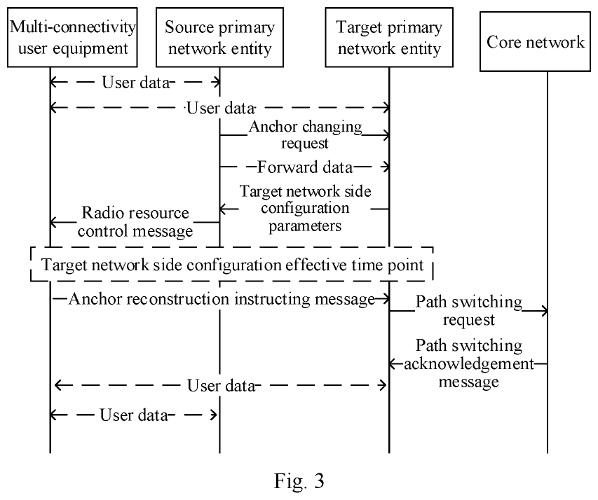

An application scenario of this second specific embodiment is the same as or similar to the first particular embodiment, and user data can be transferred seamlessly by changing an anchor at a specified time point in this second specific embodiment; and as illustrated in FIG. 3, a particular process thereof is as follows.

The source primary network entity selects one of at least one source secondary network entity of the source network side as a target primary network entity based upon a radio channel characteristic management strategy, an operating load management strategy, a path delay management strategy, or another radio resource management strategy of the multi-connectivity user equipment, where the selecting triggers an anchor changing operation.

In response to the anchor changing operation, the source primary network entity initiates an anchor changing request to the target primary network entity, where the anchor changing request includes radio configuration parameters related to a signaling bearer at the source network side, and/or PDCP configuration parameters related to a data bearer at the source network side, security context information of the target network side including a Key eNodeB Star parameter, a Next Hop Chaining Count parameter, and other similar parameters, of the target network side, and a target network side configuration effective time point.

The target primary network entity receives the anchor changing request, configures and obtains target network side configuration parameters of the target network side in the mobile communication network based upon the anchor changing request, and transmits them to the source primary network entity. Specifically the target primary network entity stores a position parameter of the target network side in the mobile communication network; the target primary network entity configures and obtains radio configuration parameters related to a signaling bearer at the target network side, based upon the radio configuration parameters related to the signaling bearer at the source network side in the anchor changing request; the target primary network entity configures and obtains PDCP configuration parameters related to a data bearer at the target network side relates, based upon the PDCP configuration parameters related to the data bearer at the source network side in the anchor changing request; the target primary network entity selects an encryption algorithm of the target network side based upon the security context information of the target network side; the target primary network entity updates radio parameters of the physical layer, the media access control layer, and the radio resource control layer of the target primary network entity; and the target primary network entity generates a target network side configuration effective time point among the target network side configuration parameters of the target network side in the mobile communication network based upon the target network side configuration effective time point.

The source primary network entity receives the target network side configuration parameters, generates a radio resource control message of the target network side including the security context information of the target network side based upon the target network side configuration parameters, and transmits it to the multi-connectivity user equipment, where the radio resource control message further indicates the target network side configuration effective time point.

Upon reception of the radio resource control message, the multi-connectivity user equipment generates an anchor reconstruction instructing message based upon the radio resource control message, and when the target network side configuration effective time point indicated in the radio resource control message arrives, the multi-connectivity user equipment transmits the anchor reconstruction instructing message to the target primary network entity, and then enters the target network side configuration effective state of the multi-connectivity user equipment, where the anchor reconstruction instructing message includes a physical layer reconstruction instructing message, a media access control layer reconstruction instructing message, and a radio resource control layer reconstruction instructing message for the target primary network entity and the target primary network entity.

After the multi-connectivity user equipment enters the target network side configuration effective state of the multi-connectivity user equipment, it is reconstructed based upon the radio resource control message specifically by performing reconstructing and resetting operation at the media access control layer and the physical layer of the multi-connectivity user equipment, performing a reconstruction operation at the PDCP layer of the multi-connectivity user equipment to enable the security context information of the target network side to take effect while keeping PDCP sequence numbers consecutive, reconstructing a control protocol entity at the radio link layer of the multi-connectivity user equipment, and delivering service data units in the downlink radio link layer control protocol to a higher layer out of order to reconstruct the multi-connectivity user equipment. While the multi-connectivity user equipment is being reconstructed, the multi-connectivity user equipment can create and transmit a PDCP state report to the target network side.

After the time point specified by the target network side configuration effective time point parameter among the target network side configuration parameters arrives, the target primary network entity enters the target network side configuration effective state; and after the target primary network entity obtains the anchor reconstruction instructing message generated and transmitted by the multi-connectivity user equipment based upon the radio resource control message, the target primary network entity changes a signaling endpoint and/or a data path of the core network from the source primary network entity to the target primary network entity based upon the target network side configuration parameters of the target network side in the mobile communication network, that is, a path switching operation on the core network is completed. The switching operation is similar to a path switching operation subsequent to legacy X2 switching.

The target primary network entity reconstructs the target network side based upon the anchor reconstruction instructing message and the target network side configuration parameters, so that the target primary network entity becomes a target anchor of the multi-connectivity user equipment, and the source primary network entity becomes one of target secondary network entities of the target network side, where the target network side is reconstructed as follows: the target primary network entity starts the target network side to be reconstructed, based upon the anchor reconstruction instructing message; the target primary network entity migrates a PDCP entity in the source primary network entity to the target primary network entity based upon the target network side configuration parameters of the target network side in the mobile communication network; the target primary network entity performs resetting and reconstructing operations on the target primary network entity and all the target primary network entities of the target network side at the media access control layer and the physical layer of the target primary network entity based upon the anchor reconstruction instructing message or the target network side configuration parameters; the target primary network entity reconstructs a radio link layer control protocol entity based upon the anchor reconstruction instructing message or the target network side configuration parameters, and delivers service data units in the uplink radio link layer control protocol to a higher layer out of order; the target primary network entity performs a reconstructing operation at the PDCP layer based upon the target network side configuration parameters to validate the security context information of the target network side while keeping PDCP sequence numbers consecutive; and the target primary network entity is controlled based upon the target network side configuration parameters to discard protocol data units which are not acknowledged in the downlink, to reconstruct the target network side. While the target network side is being reconstructed, the target primary network entity can create and transmit a PDCP state report to the multi-connectivity user equipment.

Based upon the same inventive idea, an embodiment of the invention provides an apparatus 100 for shortening an interruption delay, and reference can be made to the description of the method embodiment for a specific implementation of the apparatus, so a repeated description thereof will be omitted here.

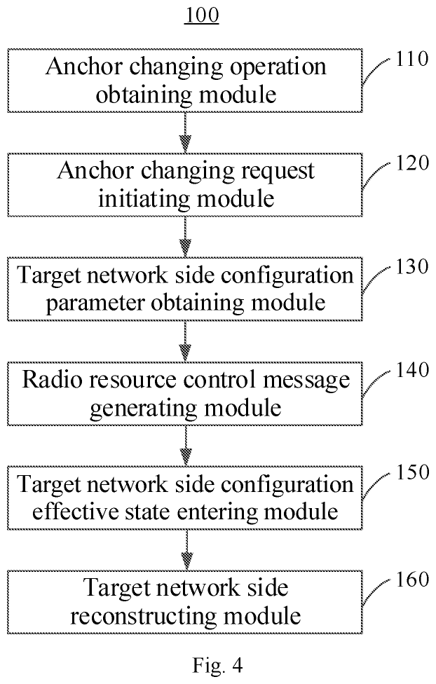

As illustrated in FIG. 4, the apparatus includes an anchor changing operation obtaining module 110, an anchor changing request initiating module 120, a target network side configuration parameter obtaining module 130, a radio resource control message generating module 140, a target network side configuration effective state entering module 150, and a target network side reconstructing module 160.

The anchor changing operation obtaining module 110 is configured to trigger an anchor changing operation at the source network side in a mobile communication network, where the anchor changing operation is an operation triggered by a source primary network entity selecting one of at least one source secondary network entity of the source network side as a target primary network entity based upon a radio resource management strategy of a multi-connectivity user equipment, and the source primary network entity is a source anchor of the multi-connectivity user equipment.

The anchor changing request initiating module 120 is configured, in response to the anchor changing operation, to initiate an anchor changing request to the target primary network entity.

The target network side configuration parameter obtaining module 130 is configured to receive the anchor changing request, and to configure and obtain target network side configuration parameters of the target network side in the mobile communication network based upon the anchor changing request.

The radio resource control message generating module 140 is configured to receive the target network side configuration parameters, and to generate a radio resource control message of the target network side based upon the target network side configuration parameters.

The target network side configuration effective state entering module 150 is configured to enter a target network side configuration effective state upon reception of an anchor reconstruction instructing message generated and transmitted by the multi-connectivity user equipment based upon the radio resource control message.

The target network side reconstructing module 160 is configured to reconstruct the target network side based upon the anchor reconstruction instructing message and the target network side configuration parameters, so that the target primary network entity becomes a target anchor of the multi-connectivity user equipment, and the source primary network entity becomes one of target secondary network entities of the target network side.

In a possible implementation, the target network side configuration parameter obtaining module 130 is configured: to store a position parameter of the target network side in the mobile communication network, and to configure and obtain radio configuration parameters related to a signaling bearer at the target network side, and/or PDCP configuration parameters related to a data bearer at the target network side, based upon the anchor changing request.

In a possible implementation, when the anchor changing request further includes radio configuration parameters related to a signaling bearer at the source network side, and/or PDCP configuration parameters related to a data bearer at the source network side, the target network side configuration parameter obtaining module 130 is further configured to configure and obtain the radio configuration parameters related to the signaling bearer at the target network side, based upon the radio configuration parameters related to the signaling carrier of the source network side in the anchor changing request, so that during reconstructing of the target network side, the target primary network entity changes a signaling endpoint and/or a data path of the core network from the source primary network entity to the target primary network entity based upon the target network side configuration parameters of the target network side in the mobile communication network; and to configure and obtain the PDCP configuration parameters related to the data bearer of the target network side based upon the PDCP configuration parameters related to the data bearer at the source network side in the anchor changing request relates, so that during reconstructing of the target network side, the target primary network entity migrates a PDCP entity in the source primary network entity to the target primary network entity based upon the target network side configuration parameters of the target network side in the mobile communication network.

In a possible implementation, when the anchor changing request further includes security context information of the target network side, the target network side configuration parameter obtaining module 130 is further configured to select an encryption algorithm of the target network side based upon the security context information of the target network side.

In a possible implementation, the security context information of the target network side includes: a Key eNodeB Star parameter and a Next Hop Chaining Count parameter of the target network side.

In a possible implementation, the radio resource control message generating module 140 is configured: to receive the target network side configuration parameters, and to generate the radio resource control message of the target network side including the security context information of the target network side based upon the target network side configuration parameters.

In a possible implementation, the apparatus further includes an anchor reconstruction instructing message transmitting module.

The anchor reconstruction instructing message transmitting module is configured to cause the multi-connectivity user equipment to be in a target network side configuration effective state of the multi-connectivity user equipment, and to be reconstructed based upon the radio resource control message, after the multi-connectivity user equipment transmits the anchor reconstruction instructing message to the target primary network entity.

In a possible implementation, the apparatus further includes a multi-connectivity user equipment reconstructing module.

The multi-connectivity user equipment reconstructing module is configured to perform reconstructing and resetting operations at the media access control layer and the physical layer of the multi-connectivity user equipment; to perform a reconstructing operation at the PDCP layer of the multi-connectivity user equipment to enable the security context information of the target network side to take effect while keeping PDCP sequence numbers consecutive; and to reconstruct a control protocol entity at the radio link layer of the multi-connectivity user equipment, and to deliver service data units in the downlink radio link layer control protocol to a higher layer out of order to reconstruct the multi-connectivity user equipment.

In a possible implementation, when the anchor changing request further includes a target network side configuration effective time point, the target network side configuration parameter obtaining module 130 is further configured to generate a target network side configuration effective time point parameter among the target network side configuration parameters of the target network side in the mobile communication network based upon the target network side configuration effective time point, so that the target primary network entity enters a target network side configuration effective state when the target network side configuration effective time point arrives, and/or the multi-connectivity user equipment transmits the anchor reconstruction instructing message to the target primary network entity at the target network side configuration effective time point, and/or the multi-connectivity user equipment is in a target network side configuration effective state of the multi-connectivity user equipment, and is reconstructed based upon the radio resource control message.

In a possible implementation, the radio resource management strategy of the multi-connectivity user equipment includes: a radio channel characteristic management strategy, an operating load management strategy, and/or a path delay management strategy of the multi-connectivity user equipment.

In a possible implementation, the target network side reconstructing module 160 is configured to start the target network side to be reconstructed, based upon the anchor reconstruction instructing message; to perform resetting and reconstructing operations on the target primary network entity and all the target primary network entities of the target network side at the media access control layer and the physical layer of the target primary network entity based upon the anchor reconstruction instructing message or the target network side configuration parameters; to reconstruct a radio link layer control protocol entity based upon the anchor reconstruction instructing message or the target network side configuration parameters, and to deliver service data units in the uplink radio link layer control protocol to a higher layer out of order; to perform a reconstructing operation at the PDCP layer based upon the target network side configuration parameters to enable the security context information of the target network side to take effect while keeping PDCP sequence numbers consecutive; and to control the target primary network entity based upon the target network side configuration parameters to discard protocol data units which are not acknowledged in the downlink, to reconstruct the target network side.

In a possible implementation, the anchor reconstruction instructing message includes: a physical layer reconstruction instructing message, a media access control layer reconstruction instructing message, and a radio resource control layer reconstruction instructing message for the target primary network entity and the target primary network entity.

Based upon the same inventive idea, an embodiment of the invention further provides a mobile communication network 200, and reference can be made to the description of the method embodiment for a specific implementation of the a mobile communication network 200, so a repeated description thereof will be omitted here.

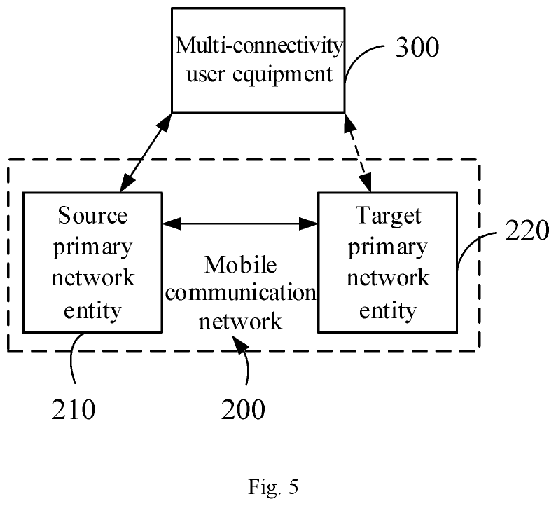

As illustrated in FIG. 5, the source network side of the mobile communication network 200 includes a source primary network entity 210, and at least one source secondary network entity wirelessly connected with the source primary network entity 210, the source primary network entity 210 is a source anchor of a multi-connectivity user equipment 300, the at least one source secondary network entity can be connected with the multi-connectivity user equipment 300 over a wireless network, and one of the at least one source secondary network entity is selected by the source primary network entity 210 as a target primary network entity 220 based upon a radio resource management strategy of the multi-connectivity user equipment 300.

The source primary network entity 210 is configured to trigger an anchor changing operation; in response to the anchor changing operation, to initiate an anchor changing request to the target primary network entity 220; and to receive target network side configuration parameters, and to generate a radio resource control message of the target network side based upon the target network side configuration parameters.

The target primary network entity 220 is configured to receive the anchor changing request, to configure and obtain the target network side configuration parameters of the target network side in the mobile communication network 200 based upon the anchor changing request; to enter a target network side configuration effective state upon reception of an anchor reconstruction instructing message generated and transmitted by the multi-connectivity user equipment 300 based upon the radio resource control message; and to reconstruct the target network side based upon the anchor reconstruction instructing message and the target network side configuration parameters, so that the target primary network entity 220 becomes a target anchor of the multi-connectivity user equipment 300, and the source primary network entity 210 becomes one of target secondary network entities of the target network side.

In a possible implementation, the target primary network entity 220 is further configured to store a position parameter of the target network side in the mobile communication network 200, and to configure and obtain radio configuration parameters related to a signaling bearer at the target network side, and/or PDCP configuration parameters related to a data bearer at the target network side, based upon the anchor changing request.

In a possible implementation, the target primary network entity 220 is further configured to configure and obtain the radio configuration parameters related to the signaling bearer at the target network side, based upon radio configuration parameters related to a signaling bearer of the source network side in the anchor changing request relates, so that during reconstructing of the target network side, the target primary network entity changes a signaling endpoint and/or a data path of the core network from the source primary network entity 210 to the target primary network entity 220 based upon the target network side configuration parameters of the target network side in the mobile communication network 200; and to configure and obtain the PDCP configuration parameters related to the data bearer of the target network side based upon PDCP configuration parameters related to a data bearer at the source network side in the anchor changing request, so that during reconstructing of the target network side, the target primary network entity migrates a PDCP entity in the source primary network entity 210 to the target primary network entity based upon the target network side configuration parameters of the target network side in the mobile communication network 200.

In a possible implementation, the target primary network entity 220 is further configured to select an encryption algorithm of the target network side based upon security context information of the target network side, where the security context information of the target network side includes a Key eNodeB Star parameter and a Next Hop Chaining Count parameter of the target network side.

In a possible implementation, the source primary network entity 210 is configured to receive the target network side configuration parameters, and to generate the radio resource control message of the target network side including the security context information of the target network side based upon the target network side configuration parameters.

In a possible implementation, the multi-connectivity user equipment 300 is configured to cause the multi-connectivity user equipment 300 to be in a target network side configuration effective state of the multi-connectivity user equipment 300, and to be reconstructed based upon the radio resource control message, after the multi-connectivity user equipment 300 transmits the anchor reconstruction instructing message to the target primary network entity 220.

In a possible implementation, the multi-connectivity user equipment 300 is configured to perform reconstructing and resetting operations at the media access control layer and the physical layer of the multi-connectivity user equipment 300; to perform a reconstructing operation at the PDCP layer of the multi-connectivity user equipment 300 to enable the security context information of the target network side to take effect while keeping PDCP sequence numbers consecutive; and to reconstruct a control protocol entity at the radio link layer of the multi-connectivity user equipment 300, and to deliver service data units in the downlink radio link layer control protocol to a higher layer out of order to reconstruct the multi-connectivity user equipment 300.

In a possible implementation, the target primary network entity 220 is further configured to generate a target network side configuration effective time point parameter among the target network side configuration parameters of the target network side in the mobile communication network 200 based upon a target network side configuration effective time point, so that the target primary network entity enters a target network side configuration effective state when the target network side configuration effective time point arrives, and/or the multi-connectivity user equipment 300 can transmit the anchor reconstruction instructing message to the target primary network entity 220 at the target network side configuration effective time point, and/or the multi-connectivity user equipment 300 can be in a target network side configuration effective state of the multi-connectivity user equipment 300, and can be reconstructed based upon the radio resource control message.

In a possible implementation, the target primary network entity configured to reconstruct the target network side is configured: to start the target network side to be reconstructed, based upon the anchor reconstruction instructing message; to perform resetting and reconstructing operations on the target primary network entity 220 and all the target primary network entities of the target network side at the media access control layer and the physical layer of the target primary network entity based upon the anchor reconstruction instructing message or the target network side configuration parameters; to reconstruct a radio link layer control protocol entity based upon the anchor reconstruction instructing message or the target network side configuration parameters, and to deliver service data units in the uplink radio link layer control protocol to a higher layer out of order; to perform a reconstructing operation at the PDCP layer based upon the target network side configuration parameters to enable the security context information of the target network side to take effect while keeping PDCP sequence numbers consecutive; and to control the target primary network entity 220 based upon the target network side configuration parameters to discard protocol data units which are not acknowledged in the downlink, to reconstruct the target network side.

In a possible implementation, an embodiment of the invention further provides a user equipment, and reference can be made to the description of the method embodiment for a particular implementation of the user equipment, so a repeated description thereof will be omitted here.

The user equipment is configured to receive a radio resource control message of the target network side transmitted by a source primary network entity of the source network side in a mobile communication network with which the user equipment remains connected, where the radio resource control message of the target network side is configured and obtained by a target primary network entity based upon an anchor changing request transmitted by the source primary network entity; and to generate an anchor reconstruction instructing message based upon the radio resource control message, and to transmit the anchor reconstruction instructing message to the target primary network entity at the target network side in the mobile communication network, so that the target primary network entity enters a target network side configuration effective state, and reconstructs the target network side, upon reception of the anchor reconstruction instructing message.

The user equipment can be connected concurrently with more than two network entities in the mobile communication network, and the source primary network entity is a source anchor of the multi-connectivity user equipment, the target primary network entity is selected by the source primary network entity from at least one source secondary network entity at the source network side based upon a radio resource management strategy of the multi-connectivity user equipment, and the target primary network entity is a target anchor of the multi-connectivity user equipment when the target network side is in the target network side configuration effective state.

In a possible implementation, the user equipment enters a target network side configuration effective state of the user equipment after transmitting the anchor reconstruction instructing message to the target primary network entity, or when a target network side configuration effective time point arrives.

In a possible implementation, after the user equipment enters the target network side configuration effective state of the user equipment, the user equipment can perform reconstructing and resetting operations at the media access control layer and the physical layer of the multi-connectivity user equipment.

The user equipment can perform a reconstructing operation at the PDCP layer of the multi-connectivity user equipment to enable security context information of the target network side to take effect while keeping PDCP sequence numbers consecutive.

The user equipment can reconstruct a control protocol entity at the radio link layer of the multi-connectivity user equipment, and deliver service data units in the downlink radio link layer control protocol to a higher layer out of order to reconstruct the multi-connectivity user equipment.

Where the security context information of the target network side is included in the radio resource control message.

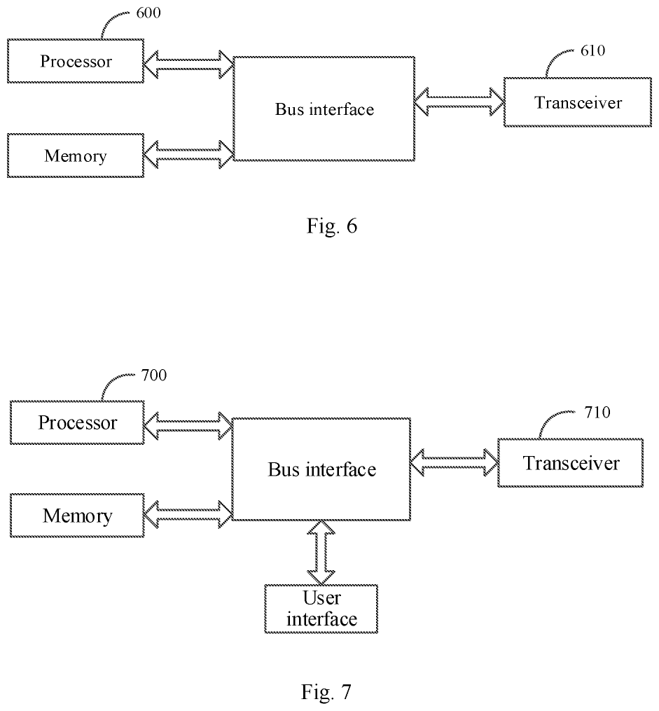

As illustrated in FIG. 6, an embodiment of the invention provides an apparatus for shortening an interruption delay, applicable to a mobile communication network, where the apparatus includes at least a processor 600 and a transceiver 610.

The processor 600 is configured to read and execute program in a memory: when an anchor changing operation is triggered at the source network side in the mobile communication network, to receive an anchor changing request initiated in response to the anchor changing operation, where the anchor changing operation is an operation triggered by a source primary network entity selecting one of at least one source secondary network entity of the source network side as a target primary network entity based upon a radio resource management strategy of a multi-connectivity user equipment, and the source primary network entity is a source anchor of the multi-connectivity user equipment; to configure and obtain target network side configuration parameters of the target network side in the mobile communication network based upon the anchor changing request; to receive the target network side configuration parameters, and to generate a radio resource control message of the target network side based upon the target network side configuration parameters; to enter a target network side configuration effective state upon reception of an anchor reconstruction instructing message generated and transmitted by the multi-connectivity user equipment based upon the radio resource control message; and to reconstruct the target network side based upon the anchor reconstruction instructing message and the target network side configuration parameters, so that the target primary network entity becomes a target anchor of the multi-connectivity user equipment, and the source primary network entity becomes one of target secondary network entities of the target network side.

The transceiver 610 is configured to receive and transmit data under the control of the processor 600.

Here in FIG. 6, the bus architecture can include any number of interconnecting buses and bridges to particularly link together various circuits including one or more processors represented by the processor 600, and one or more memories represented by the memory. The bus architecture can further link together various other circuits, e.g., a peripheral device, a manostat, a power management circuit, etc., all of which are well known in the art, so a further description thereof will be omitted in this context. The bus interface serves as an interface. The transceiver 610 can be a number of elements, e.g., a transmitter and a receiver, which are units for communication with various other devices over a transmission medium. The processor 600 is responsible for managing the bus architecture and performing normal processes, and the memory can store data for use by the processor 600 in performing the operations.

Optionally the processor 600 is configured: to store a position parameter of the target network side in the mobile communication network, and to configure and obtain radio configuration parameters related to a signaling bearer at the target network side relates, and/or PDCP configuration parameters related to a data bearer at the target network side, based upon the anchor changing request.

Optionally the processor 600 is further configured: when the anchor changing request further includes radio configuration parameters related to a signaling bearer at the source network side, and/or PDCP configuration parameters related to a data bearer at the source network side, to configure and obtain the radio configuration parameters related to the signaling bearer at the target network side, based upon the radio configuration parameters related to the signaling bearer of the source network side in the anchor changing request, so that during reconstructing of the target network side, the target primary network entity changes a signaling endpoint and/or a data path of the core network from the source primary network entity to the target primary network entity based upon the target network side configuration parameters of the target network side in the mobile communication network; and to configure and obtain the

PDCP configuration parameters related to the data bearer of the target network side based upon the PDCP configuration parameters related to the data bearer at the source network side in the anchor changing request, so that during reconstructing of the target network side, the target primary network entity migrates a PDCP entity in the source primary network entity to the target primary network entity based upon the target network side configuration parameters of the target network side in the mobile communication network.

Optionally the processor 600 is further configured: when the anchor changing request further includes security context information of the target network side, to select an encryption algorithm of the target network side based upon the security context information of the target network side.

Optionally the security context information of the target network side includes: a Key eNodeB Star parameter and a Next Hop Chaining Count parameter of the target network side.

Optionally the processor 600 is configured: to receive the target network side configuration parameters, and to generate a radio resource control message of the target network side including the security context information of the target network side based upon the target network side configuration parameters.

Optionally the processor 600 is further configured: to cause the multi-connectivity user equipment to be in a target network side configuration effective state of the multi-connectivity user equipment, and to be reconstructed based upon the radio resource control message, upon reception of the anchor reconstruction instructing message transmitted by the multi-connectivity user equipment.

Optionally the processor 600 is further configured: to perform reconstructing and resetting operations at the media access control layer and the physical layer of the multi-connectivity user equipment; to perform a reconstructing operation at the PDCP layer of the multi-connectivity user equipment to enable the security context information of the target network side to take effect while keeping PDCP sequence numbers consecutive; and to reconstruct a control protocol entity at the radio link layer of the multi-connectivity user equipment, and to deliver service data units in the downlink radio link layer control protocol to a higher layer out of order to reconstruct the multi-connectivity user equipment.

Optionally the processor 600 is further configured: when the anchor changing request further includes a target network side configuration effective time point, to generate a target network side configuration effective time point parameter among the target network side configuration parameters of the target network side in the mobile communication network based upon the target network side configuration effective time point, so that the target primary network entity enters a target network side configuration effective state when the target network side configuration effective time point arrives, and/or the multi-connectivity user equipment can transmit the anchor reconstruction instructing message to the target primary network entity at the target network side configuration effective time point, and/or the multi-connectivity user equipment can be in a target network side configuration effective state of the multi-connectivity user equipment, and can be reconstructed based upon the radio resource control message.

Optionally the radio resource management strategy of the multi-connectivity user equipment includes: a radio channel characteristic management strategy, an operating load management strategy, and/or a path delay management strategy of the multi-connectivity user equipment.

Optionally the processor 600 is configured: to start the target network side to be reconstructed, based upon the anchor reconstruction instructing message; to perform resetting and reconstructing operations at the media access control layer and the physical layer based upon the anchor reconstruction instructing message or the target network side configuration parameters; to reconstruct a radio link layer control protocol entity based upon the anchor reconstruction instructing message or the target network side configuration parameters, and to deliver service data units in the uplink radio link layer control protocol to a higher layer out of order; to perform a reconstructing operation at the PDCP layer based upon the target network side configuration parameters to enable the security context information of the target network side to take effect while keeping PDCP sequence numbers consecutive; and to discard protocol data units which are not acknowledged in the downlink, based upon the target network side configuration parameters to reconstruct the target network side.

Optionally the anchor reconstruction instructing message includes: A a physical layer reconstruction instructing message, a media access control layer reconstruction instructing message, and a radio resource control layer reconstruction instructing message for the target primary network entity and the target primary network entity.

As illustrated in FIG. 7, an embodiment of the invention provides an apparatus for shortening an interruption delay, applicable to a mobile communication network, where the apparatus includes at least a processor 700 and a transceiver 710.

The processor 700 is configured to read and execute program in a memory: to receive a radio resource control message of the target network side transmitted by a source primary network entity of the source network side in the mobile communication network with which the user equipment remains connected, where the radio resource control message of the target network side is configured and obtained by a target primary network entity based upon an anchor changing request transmitted by the source primary network entity; and to generate an anchor reconstruction instructing message based upon the radio resource control message, and to transmit the anchor reconstruction instructing message to the target primary network entity at the target network side in the mobile communication network, so that the target primary network entity enters a target network side configuration effective state, and reconstructs the target network side, upon reception of the anchor reconstruction instructing message.

Where the processor 700 can be connected concurrently with more than two network entities in the mobile communication network through the transceiver 710, and the source primary network entity is a source anchor of the multi-connectivity user equipment, the target primary network entity is selected by the source primary network entity from at least one source secondary network entity at the source network side based upon a radio resource management strategy of the multi-connectivity user equipment, and the target primary network entity is a target anchor of the multi-connectivity user equipment when the target network side is in the target network side configuration effective state.

The transceiver 710 is configured to receive and transit data under the control of the processor 700.

Here in FIG. 7, the bus architecture can include any number of interconnecting buses and bridges to particularly link together various circuits including one or more processors represented by the processor 700, and one or more memories represented by the memory. The bus architecture can further link together various other circuits, e.g., a peripheral device, a manostat, a power management circuit, etc., all of which are well known in the art, so a further description thereof will be omitted in this context. The bus interface serves as an interface. The transceiver 710 can be a number of elements, e.g., a transmitter and a receiver, which are units for communication with various other devices over a transmission medium. For different user equipments, the user interface can also be an interface via which devices are connected internally and externally as needed, and the connected devices include but will not be limited to a keypad, a monitor, a speaker, a microphone, a joystick, etc.

The processor 700 is responsible for managing the bus architecture and performing normal processes, and the memory can store data for use by the processor 700 in performing the operations.

Optionally the processor 700 is configured: to enter a target network side configuration effective state of the user equipment after transmitting the anchor reconstruction instructing message to the target primary network entity, or when a target network side configuration enabling point of time arrives.

Optionally the processor 700 is configured: after the user equipment enters the target network side configuration effective state of the user equipment, to perform reconstructing and resetting operations at the media access control layer and the physical layer of the multi-connectivity user equipment; to perform a reconstructing operation at the PDCP layer of the multi-connectivity user equipment to enable security context information of the target network side to take effect while keeping PDCP sequence numbers consecutive; and to reconstruct a control protocol entity at the radio link layer of the multi-connectivity user equipment, and to deliver service data units in the downlink radio link layer control protocol to a higher layer out of order to reconstruct the multi-connectivity user equipment.

Where the security context information of the target network side is included in the radio resource control message.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore the invention can be embodied in the form of a computer program product embodied in one or more computer usable storage mediums (including but not limited to a disk memory, a CD-ROM, an optical memory, etc.) in which computer usable program codes are contained.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Although the preferred embodiments of the invention have been described, those skilled in the art benefiting from the underlying inventive concept can make additional modifications and variations to these embodiments. Therefore the appended claims are intended to be construed as encompassing the preferred embodiments and all the modifications and variations coming into the scope of the invention.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. A method for shortening an interruption delay, applicable to a mobile communication network, the method comprising:
triggering, by a source primary network entity at a source network side in the mobile communication network, an anchor changing operation, wherein the anchor changing operation is an operation triggered by the source primary network entity selecting one of at least one source secondary network entity of the source network side as a target primary network entity based upon a radio resource management strategy of a multi-connectivity user equipment, and the source primary network entity is a source anchor of the multi-connectivity user equipment;
in response to the anchor changing operation, initiating, by the source primary network entity, an anchor changing request to the target primary network entity;
receiving, by the target primary network entity, the anchor changing request, and configuring and obtaining target network side configuration parameters of the target network side in the mobile communication network based upon the anchor changing request;
receiving, by the source primary network entity, the target network side configuration parameters, and generating a radio resource control message of the target network side based upon the target network side configuration parameters;
upon reception of an anchor reconstruction instructing message generated and transmitted by the multi-connectivity user equipment based upon the radio resource control message, entering, by the target primary network entity, a target network side configuration effective state; and
reconstructing, by the target primary network entity, the target network side based upon the anchor reconstruction instructing message and the target network side configuration parameters, so that the target primary network entity becomes a target anchor of the multi-connectivity user equipment, and the source primary network entity becomes one of target secondary network entities of the target network side.

2. The method according to claim 1, wherein receiving, by the target primary network entity, the anchor changing request, and configuring and obtaining the target network side configuration parameters of the target network side in the mobile communication network based upon the anchor changing request comprises:
storing, by the target primary network entity, a position parameter of the target network side in the mobile communication network, and configuring and obtaining radio configuration parameters related to a signaling bearer at the target network side, and/or PDCP configuration parameters related to a data bearer at the target network side, based upon the anchor changing request.

3. The method according to claim 2, wherein the anchor changing request further comprises radio configuration parameters related to a signaling bearer at the source network side, and/or PDCP configuration parameters related to a data bearer at the source network side; and
receiving, by the target primary network entity, the anchor changing request, and configuring and obtaining the target network side configuration parameters of the target network side in the mobile communication network based upon the anchor changing request further comprises:
configuring and obtaining, by the target primary network entity, the radio configuration parameters related to the signaling bearer at the target network side, based upon the radio configuration parameters related to the signaling bearer of the source network side in the anchor changing request, so that during reconstructing of the target network side, the target primary network entity changes a signaling endpoint and/or a data path of the core network from the source primary network entity to the target primary network entity based upon the target network side configuration parameters of the target network side in the mobile communication network; and
configuring and obtaining, by the target primary network entity, the PDCP configuration parameters related to the data bearer of the target network side based upon the PDCP configuration parameters related to the data bearer at the source network side in the anchor changing request, so that during reconstructing of the target network side, the primary network entity migrates a PDCP entity in the source primary network entity to the target primary network entity based upon the target network side configuration parameters of the target network side in the mobile communication network.

4. The method according to claim 1, wherein the anchor changing request further comprises security context information of the target network side; and receiving, by the target primary network entity, the anchor changing request, and configuring and obtaining the target network side configuration parameters of the target network side in the mobile communication network based upon the anchor changing request further comprises:
selecting, by the target primary network entity, an encryption algorithm of the target network side based upon the security context information of the target network side.

5. The method according to claim 4, wherein the security context information of the target network side comprises:
a Key eNodeB Star parameter and a Next Hop Chaining Count parameter of the target network side.

6. The method according to claim 4, wherein receiving, by the source primary network entity, the target network side configuration parameters, and generating the radio resource control message of the target network side based upon the target network side configuration parameters comprises:
receiving, by the source primary network entity, the target network side configuration parameters, and generating the radio resource control message of the target network side comprising the security context information of the target network side based upon the target network side configuration parameters.

7. The method according to claim 1, wherein the multi-connectivity user equipment is in a target network side configuration effective state of the multi-connectivity user equipment, and is reconstructed based upon the radio resource control message, after transmitting the anchor reconstruction instructing message to the target primary network entity.

8. The method according to claim 7, wherein the multi-connectivity user equipment is reconstructed based upon the radio resource control message in the steps of:
performing reconstructing and resetting operations at a media access control layer and a physical layer of the multi-connectivity user equipment;
performing a reconstructing operation at a PDCP layer of the multi-connectivity user equipment to enable the security context information of the target network side to take effect while keeping PDCP sequence numbers consecutive; and
reconstructing a control protocol entity at a radio link layer of the multi-connectivity user equipment, and delivering service data units in a downlink radio link layer control protocol to a higher layer out of order to reconstruct the multi-connectivity user equipment.

9. The method according to claim 1, wherein the anchor changing request further comprises a target network side configuration effective time point; and
receiving, by the target primary network entity, the anchor changing request, and configuring and obtaining the target network side configuration parameters of the target network side in the mobile communication network based upon the anchor changing request further comprises:
generating, by the target primary network entity, a target network side configuration effective time point parameter among the target network side configuration parameters of the target network side in the mobile communication network based upon the target network side configuration effective time point, so that the target primary network entity enters a target network side configuration effective state when the target network side configuration effective time point arrives, and/or the multi-connectivity user equipment can transmit the anchor reconstruction instructing message to the target primary network entity at the target network side configuration effective time point, and/or the multi-connectivity user equipment is in a target network side configuration effective state of the multi-connectivity user equipment, and is reconstructed based upon the radio resource control message, at the target network side configuration effective time point.

10. The method according to claim 1, wherein the radio resource management strategy of the multi-connectivity user equipment comprises:
a radio channel characteristic management strategy, an operating load management strategy, and/or a path delay management strategy of the multi-connectivity user equipment.

11. The method according to claim 1, wherein reconstructing, by the target primary network entity, the target network side based upon the anchor reconstruction instructing message and the target network side configuration parameters comprises:
starting, by the target primary network entity, the target network side to be reconstructed, based upon the anchor reconstruction instructing message;
performing, by the target primary network entity, resetting and reconstructing operations on the target primary network entity and all the target primary network entities of the target network side at a media access control layer and a physical layer of the target primary network entity based upon the anchor reconstruction instructing message or the target network side configuration parameters;
reconstructing, by the target primary network entity, a radio link layer control protocol entity based upon the anchor reconstruction instructing message or the target network side configuration parameters, and delivering service data units in the uplink radio link layer control protocol to a higher layer out of order;
performing, by the target primary network entity, a reconstructing operation at a PDCP layer based upon the target network side configuration parameters to enable security context information of the target network side to take effect while keeping PDCP sequence numbers consecutive; and
controlling, by the target primary network entity, the target primary network entity based upon the target network side configuration parameters to discard protocol data units which are not acknowledged in the downlink, to reconstruct the target network side.

12. The method according to claim 1, wherein the anchor reconstruction instructing message comprises:
a physical layer reconstruction instructing message, a media access control layer reconstruction instructing message, and a radio resource control layer reconstruction instructing message for the target primary network entity.

13. An apparatus for shortening an interruption delay, applicable to a mobile communication network, the apparatus comprising at least a processor and a transceiver, wherein:
the processor is configured to trigger an anchor changing operation at a source network side in the mobile communication network, wherein the anchor changing operation is an operation triggered by a source primary network entity selecting one of at least one source secondary network entity of the source network side as a target primary network entity based upon a radio resource management strategy of a multi-connectivity user equipment, and the source primary network entity is a source anchor of the multi-connectivity user equipment;
in response to the anchor changing operation, to initiate an anchor changing request to the target primary network entity;
to receive the anchor changing request, and to configure and obtain target network side configuration parameters of the target network side in the mobile communication network based upon the anchor changing request;
to receive the target network side configuration parameters, and to generate a radio resource control message of the target network side based upon the target network side configuration parameters;
to enter a target network side configuration effective state upon reception of an anchor reconstruction instructing message generated and transmitted by the multi-connectivity user equipment based upon the radio resource control message; and
to reconstruct the target network side based upon the anchor reconstruction instructing message and the target network side configuration parameters, so that the target primary network entity becomes a target anchor of the multi-connectivity user equipment, and the source primary network entity becomes one of target secondary network entities of the target network side;
the transceiver is configured to transmit and receive data under the control of the processor.

14. The apparatus according to claim 13, wherein the processor is configured:
to store a position parameter of the target network side in the mobile communication network, and to configure and obtain radio configuration parameters related to a signaling bearer at the target network side, and/or PDCP configuration parameters related to a data bearer at the target network side, based upon the anchor changing request.

15. The apparatus according to claim 14, wherein the processor is further configured, when the anchor changing request further comprises radio configuration parameters related to a signaling bearer at the source network side relates, and/or PDCP configuration parameters related to a data bearer at the source network side,
to configure and obtain the radio configuration parameters related to the signaling bearer at the target network side based upon the radio configuration parameters related to the signaling bearer of the source network side in the anchor changing request, so that during reconstructing of the target network side, the target primary network entity changes a signaling endpoint and/or a data path of the core network from the source primary network entity to the target primary network entity based upon the target network side configuration parameters of the target network side in the mobile communication network; and
to configure and obtain the PDCP configuration parameters related to the data bearer of the target network side based upon the PDCP configuration parameters related to the data bearer at the source network side in the anchor changing request, so that during reconstructing of the target network side, the target primary network entity migrates a PDCP entity in the source primary network entity to the target primary network entity based upon the target network side configuration parameters of the target network side in the mobile communication network.

16-18. (canceled)

19. The apparatus according to claim 13, wherein the processor is further configured to cause the multi-connectivity user equipment to be in a target network side configuration effective state of the multi-connectivity user equipment, and to be reconstructed based upon the radio resource control message, after the multi-connectivity user equipment transmits the anchor reconstruction instructing message to the target primary network entity.

20. The apparatus according to claim 19, wherein the processor is further configured to perform reconstructing and resetting operations at a media access control layer and a physical layer of the multi-connectivity user equipment;
to perform a reconstructing operation at a PDCP layer of the multi-connectivity user equipment to enable the security context information of the target network side to take effect while keeping PDCP sequence numbers consecutive; and
to reconstruct a control protocol entity at a radio link layer of the multi-connectivity user equipment, and to deliver service data units in a downlink radio link layer control protocol to a higher layer out of order to reconstruct the multi-connectivity user equipment.

21. The apparatus according to claim 13, wherein when the anchor changing request further comprises a target network side configuration effective time point,
the processor is further configured to generate a target network side configuration effective time point parameter among the target network side configuration parameters of the target network side in the mobile communication network based upon the target network side configuration effective time point, so that the target primary network entity enters a target network side configuration effective state when the target network side configuration effective time point arrives, and/or the multi-connectivity user equipment transmits the anchor reconstruction instructing message to the target primary network entity at the target network side configuration effective time point, and/or the multi-connectivity user equipment is in a target network side configuration effective state of the multi-connectivity user equipment, and is reconstructed based upon the radio resource control message.

22. (canceled)

23. The apparatus according to claim 13, wherein the processor is further configured:
to start the target network side to be reconstructed, based upon the anchor reconstruction instructing message;
to perform resetting and reconstructing operations on the target primary network entity and all the target secondary network entities of the target network side at a media access control layer and a physical layer of the target primary network entity based upon the anchor reconstruction instructing message or the target network side configuration parameters;
to reconstruct a radio link layer control protocol entity based upon the anchor reconstruction instructing message or the target network side configuration parameters, and to deliver service data units in the uplink radio link layer control protocol to a higher layer out of order;
to perform a reconstructing operation at a PDCP layer based upon the target network side configuration parameters to enable the security context information of the target network side to take effect while keeping PDCP sequence numbers consecutive; and
to control the target primary network entity based upon the target network side configuration parameters to discard protocol data units which are not acknowledged in the downlink, to reconstruct the target network side.

24. (canceled)

25. A user equipment, applicable to a mobile communication network, wherein the user equipment comprises at least a processor and a transceiver; wherein:
the processor is configured to receive a radio resource control message of a target network side transmitted by a source primary network entity of a source network side in the mobile communication network with which the user equipment remains connected, wherein the radio resource control message of the target network side is configured and obtained by a target primary network entity based upon an anchor changing request transmitted by the source primary network entity; and
to generate an anchor reconstruction instructing message based upon the radio resource control message, and to transmit the anchor reconstruction instructing message to the target primary network entity at the target network side in the mobile communication network, so that the target primary network entity enters a target network side configuration effective state, and reconstructs the target network side, upon reception of the anchor reconstruction instructing message;
wherein the user equipment is capable of being connected concurrently with more than two network entities in the mobile communication network, and the source primary network entity is a source anchor of the multi-connectivity user equipment, the target primary network entity is selected by the source primary network entity from at least one source secondary network entity at the source network side based upon a radio resource management strategy of the multi-connectivity user equipment, and the target primary network entity is a target anchor of the multi-connectivity user equipment when the target network side is in the target network side configuration effective state;
the transceiver is configured to transmit and receive data under the control of the processor.

26-27. (canceled)
